(19) United States
(12) Patent Application Publication
(10) Pub. No.: US 2008/0007421 A1
(43) Pub. Date: Jan. 10, 2008

(54) MEASUREMENT-WHILE-DRILLING (MWD) TELEMETRY BY WIRELESS MEMS RADIO UNITS

(75) Inventors: Ce Richard Liu, Sugar Land, TX (US); Jing Li, Houston, TX (US)

Correspondence Address: WINSTEAD PC, P.O. BOX 50784, DALLAS, TX, 75201, US

(73) Assignee: UNIVERSITY OF HOUSTON, Houston, TX (US)

(21) Appl. No.: 11/684,386

(22) Filed: Mar. 9, 2007

Related U.S. Application Data
(60) Provisional application No. 60/780,801, filed on Mar. 9, 2006.

(30) Foreign Application Priority Data
Aug. 2, 2005 (US) PCT/US2005/027317

(51) Int. Cl. G01V 3/00

(52) U.S. Cl. 340/853.3

(57) ABSTRACT

A system for transmitting measurement-while-drilling (MWD) data from at least one downhole device positioned within a borehole containing drilling mud to at least one surface device, comprising a downhole tool positioned within the borehole, a plurality of wireless MEMS radio units, wherein the MEMS radio units are selectively positioned within the borehole at selected distances to create a relay system between the downhole device and the surface device, and wherein data from the downhole device is transmitted through the relay system of MEMS radio units to the surface device.

### RELATED APPLICATIONS

This application claims the benefit of U.S. Provisional Patent Application No. 60/780,801 filed Mar. 9, 2006.

### FIELD OF THE INVENTION

The present invention relates in general to drilling operations and more specifically to transmitting measurement-while-drilling data (MWD).

### BACKGROUND

As oil prices continue to increase, drilling for oil must become increasingly more sophisticated. Extremely deep wells (up to 36,000 feet) and even horizontal wells are now common practice in the drilling industry. In order to drill more efficiently, logging-while-drilling (LWD) or measuring-while-drilling (MWD) is becoming an increasingly common practice. More instruments (sensors and logging tools) are being placed in a drilling system to sense drilling parameters (such as pressure, fluid flow and temperature) and formation parameters (such as the presence of oil and gas in the formation layers, oil and gas quality, permeability, and reservoir boundaries).

As more data is collected in real time, more data must be transmitted from the borehole to the receivers, storage devices and processing equipment at the surface and/or elsewhere in the borehole. With more information being measured, the telemetry rate must also increase. Hence, downhole telemetry is becoming a more serious bottleneck problem in the oil industry. Additionally, there are natural barriers to the transmission of the data from downhole, which can be as deep as 30,000 feet, to the surface.

The industry has been searching for a faster wireless method to communicate downhole data to the surface for over 50 years. The traditional wireless MWD telemetry system may use mud pulse telemetry that may be very rate limited due to low carrier frequencies. Mud pulse carrier frequency is typically below 10 Hz. The acoustic telemetry tends to operate at a higher frequency, ranging from 400 Hz to 2 KHz. This speed, however, is still far below the required data rate; and the acoustic telemetry suffers from the dynamic attenuation and non-stationary noise that occur due to various phenomena associated with drilling processes like the borehole conditions, characteristics of the borehole/casing, the deviation of the borehole, the physical properties of the drilling mud, and the extent of contact between pipe and the borehole wall. Another method, electromagnetic telemetry (EM), may be restricted by a limited transmission distance.

It is, therefore, a desire to provide a higher data rate transmission method. It is a further object of the invention to handle the harsh environment in MWD with long transmission distances. It is also an object of the present invention to provide a device that can transmit data at a high data rate without having to stop drilling to transmit data.

### SUMMARY OF THE INVENTION

In view of the foregoing and other considerations, the present invention relates to a system and method for transmitting and receiving data in a measurement-while-drilling (MWD) system utilizing a wireless micro-electromechanical system (MEMS) telemetry system.

Accordingly, a system for transmitting MWD data is provided. The system includes downhole tool positioned within the borehole, a plurality of wireless MEMS radio units, wherein the MEMS radio units are selectively positioned within the borehole at selected distances to create a relay system between the downhole device and the surface device, and wherein data from the downhole device is transmitted through the relay system of MEMS radio units to the surface device.

A method for transmitting MWD data from at least one downhole device to at least one surface device is provided. The method includes the steps of positioning a plurality of wireless MEMS radio units within a borehole at selected locations, creating a relay system between the downhole device and the surface device with the plurality of MEMS radio units, and transmitting data from the downhole device through the relay system of MEMS radio units to the surface device.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is a system of transmitting MWD data using a top-release of MEMS radio units;

FIG. 2 is a system of transmitting MWD data using a bottom-release of MEMS radio units;

FIG. 3 is a system of transmitting MWD data using a downhole tool incorporating attached MEMS radio units;

FIG. 4 is a first embodiment of a MEMS radio unit of the present invention; and

FIG. 5 is a second embodiment of a MEMS radio unit of the present invention.

### DETAILED DESCRIPTION

Refer now to the drawings wherein depicted elements are not necessarily shown to scale and wherein like or similar elements are designated by the same reference numeral through the several views.

As used herein, the terms “up” and “down”; “upper” and “lower”; and other like terms indicating relative positions to a given point or element are utilized to more clearly describe some elements of the embodiments of the invention. Commonly, these terms relate to a reference point as the surface from which drilling operations are initiated as being the top point and the total depth of the well being the lowest point.

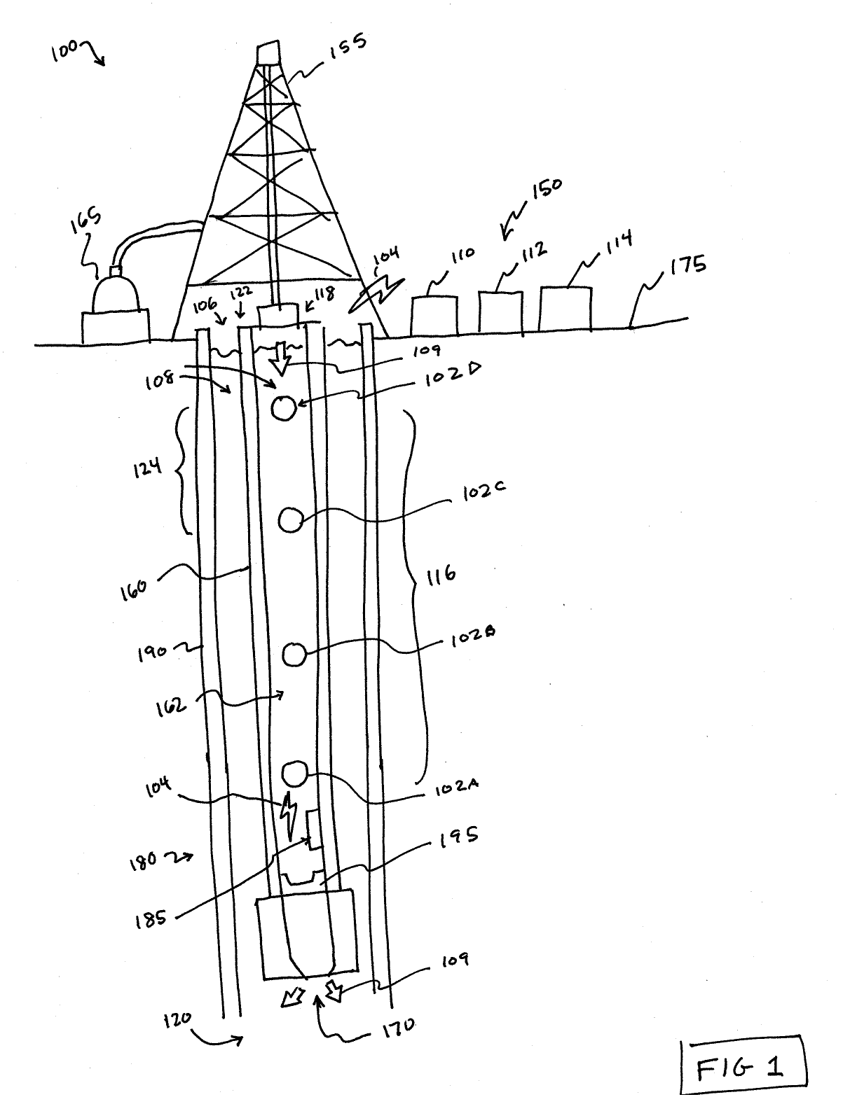

FIG. 1 is a sketch of an exemplary embodiment of the system of transmitting measurement-while-drilling (MWD) data of the present invention, indicated generally at 100. In one embodiment of the present invention, system 100 comprises a wireless micro-electromechanical system (MEMS) telemetry system. MEMS telemetry system includes one or more MEMS ratio units 102. Borehole 106 may be a wellbore, including, for example, the openhole or uncased portion of the well, having a selected depth and diameter at a selected location of earth formation 175. Casing or tubing 190 may be positioned within a section of borehole 106.

System 100 may comprise drilling rig 155 to support and position downhole tool 170 into borehole 106. Drilling rig 155 may include machinery used to drill or maintain a wellbore. For example, drilling rig 155 may include the mud tanks, the mud pumps, the derrick or mast, the drawworks, the rotary table or topdrive, the drillstring, the power generation equipment and auxiliary equipment, among other components. Drilling rig 155 may comprise an offshore rig or drilling package, for example. Downhole tool 160 may be any tool, assembly, or instrument suitable for operating in a downhole environment, including a drillstring, MWD tool, LWD tool, or any other suitable bottomhole assembly, drilling tool or downhole measurement device. For example, downhole tool 160 may include sensors 185 operable to determine selected properties of earth formation 175 or the downhole environment. Downhole tool 160 may also include one or more downhole tool ports 170. Downhole tool ports 170 may allow for the circulation of drilling mud through downhole tool 160 and the rest of system 100, for example.

System 100 may comprise drilling mud or drilling fluid 108. Drilling mud 108 may comprise any fluid or compound suitable for circulation in drilling or borehole operations. For example, drilling mud 108 may comprise water-based fluid, non-water-based fluid, or gaseous (pneumatic) fluid. Drilling mud 108 may be selected to facilitate data transmission 104. For example, oil-based drilling mud may be preferred over water-based mud because the former provides better radio frequency transmission conditions.

Drilling mud 108 may be circulated throughout selected sections of system 100, including, for example, borehole 106 and drilling rig 155. Mud circulation system 165 and/or drill rig 155 may circulate drilling mud 108 through system 100. Generally, drilling mud 108 may be pumped into borehole 106, e.g., through downhole tool 160, for example. Drilling mud 108 may then flow up borehole 106, e.g., outside of downhole tool 160, and back to the surface. In this manner, drilling mud 108 of a selected viscosity may be operable to bring up cuttings and other similar material, for example. Once the cuttings and other material are removed from drilling mud 108, e.g., by drilling rig 155, drilling mud 108 may then be recirculated by mud circulation system 165 and/or drilling rig 155, for example.

System 100 includes one or more MEMS radio units 102. MEMS radio units 102 may be communicatively coupled via network 116 to other MEMS radio units 102 and other devices. Network 116 may comprise a local network formed by or comprising a selected subset of MEMS radio units 102. MEMS radio units 102 are operable to receive data from downhole devices 180, such as downhole tool 160, sensors 185 and other MEMS radio units 102, for example. Each MEMS radio unit 102 may act as a relay station to transmit data from downhole devices 180 to surface devices 150 via other MEMS radio units 102. For example, MEMS radio unit 102A may receive data 104 from sensor 185 and then transmit this data 104 to either unit 102B, 102C or 102D, e.g., units further uphole, via network 116. This latter unit may then transmit data 104 to surface devices 150. Surface devices 150 may include receiver 110, storage device 112 and processing unit 114, among other devices and instruments. Generally, system 100 may improve its redundancy and transmission capabilities by using several MEMS radio units 102.

MEMS radio units 102 are selectively sized and fabricated to be positioned, distributed or circulated throughout selected sections of system 100. For example, FIG. 1 shows an embodiment of a top release system, e.g., units 102 may be introduced into system 100 via drilling rig 155 or mud circulation system 165 and then released near the top 122 of borehole 106. MEMS radio units 102 are released from about starting position 118 into drilling mud 108 which is then pumped down into the interior 162 of downhole tool 160. Drilling mud 108 may suspend and carry MEMS radio units 102 via mud circulation path 109. Once released, MEMS radio units 102 may begin to receive and transmit data. Downhole tool 160 may include a net or catch basin 195 to retrieve MEMS radio units 102 but still allow mud 108 to continue to flow through into borehole 106 via downhole tool port 170. Note that MEMS radio units 102 are preferably sufficiently small and inexpensive such that the possible destruction of units 102 by downhole tool 160, e.g., by a drill bit, for example, will not result in serious damage to downhole tool 160 or represent a significant loss of resources.

MEMS radio units 102 may be selectively released to be spaced at about a selected separation distance 124 from each other to facilitate data reception and transmission. For example, separation distance 124 may be selected based on the individual data transmission and receiving capabilities of MEMS radio units 102, e.g., signal range. The ability of MEMS radio units 102 to transmit through mud 108 or other environmental factors may also be considered in determining separation distance 124.

Accordingly, as drilling mud 108 circulates through system 100, MEMS radio units 102 may also move through system 100 to collect and transmit data 104 through network 116. In this manner, the transmission capabilities of network 116 may not necessarily be limited by the depth of borehole 106, because network 116 may rely on the circulation of mud 108 and MEMS radio units 102 (e.g., acting as relay stations), rather than the raw transmission strength of downhole devices 180, for example, to send and receive data 104 to the surface.

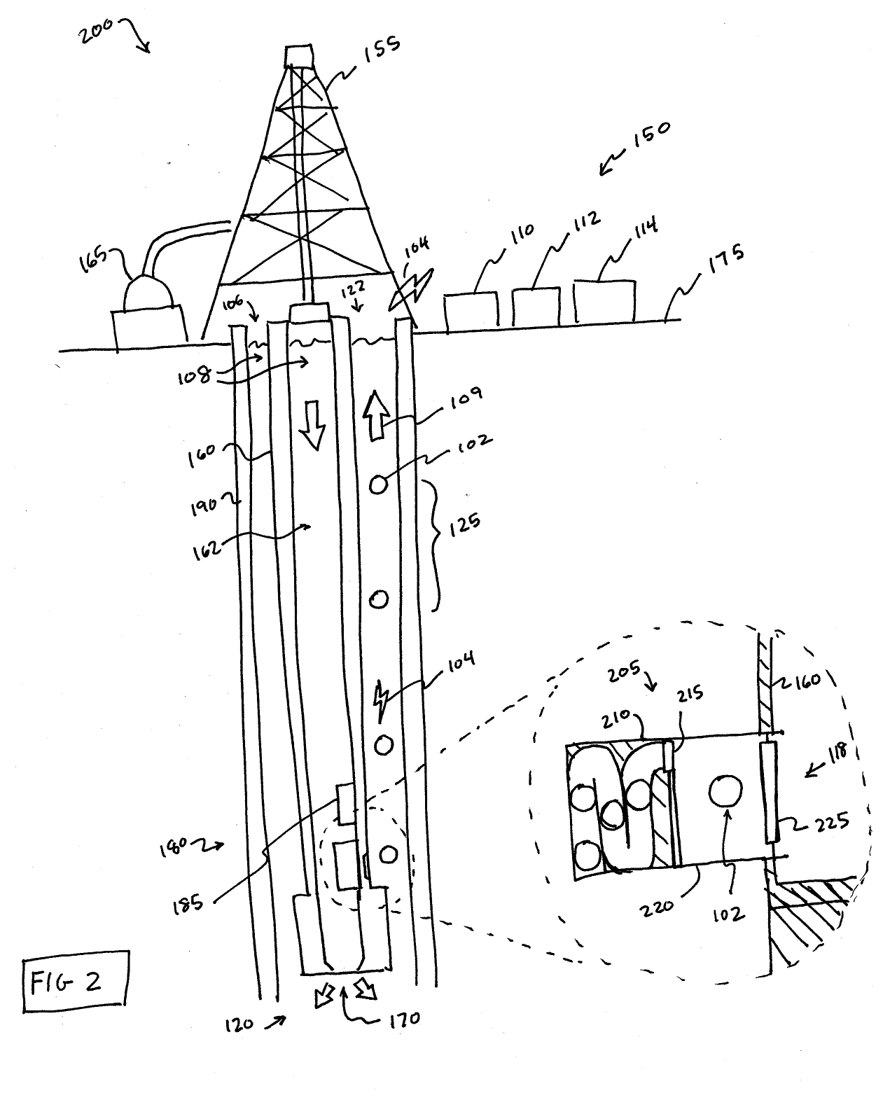

FIG. 2 shows another embodiment of distributing or positioning the MEMS radio units of the present invention. System 200 employs a bottom-release method of distributing MEMS units 102. Downhole tool 160 includes compartment 205 for storing and selectively releasing MEMS radio units 102. Compartment 205 may include a storage chamber 210 to contain or house the MEMS radio units 102. Storage chamber 210 may be shaped or configured to release MEMS radio units 102 one at a time and in a pre-selected order, e.g., metered release. Compartment 205 may include release chamber 220 to facilitate the controlled release of MEMS radio units 102 into borehole 106. First compartment gate 215 may be opened to release a MEMS radio unit 102 into release chamber 220 and then closed. Second compartment gate 225 may then be opened to release the MEMS radio unit 102 into drilling mud 108 to be carried upwards toward the surface by mud flow 109.

Downhole tool 160 may include sensors 185 operable to measure the resistivity or conductivity of drilling mud 108 and accordingly adjust the release rate of MEMS radio units 102. For example, if the resistivity of mud 108 is high, the MEMS radio units 102 may be able to transmit and receive data over a longer distance and, therefore, downhole tool 160 may release the MEMS radio units 102 more slowly. Conversely, if the resistivity of mud 108 is low, downhole tool 160 may need to release the MEMS radio units 102 more frequently.

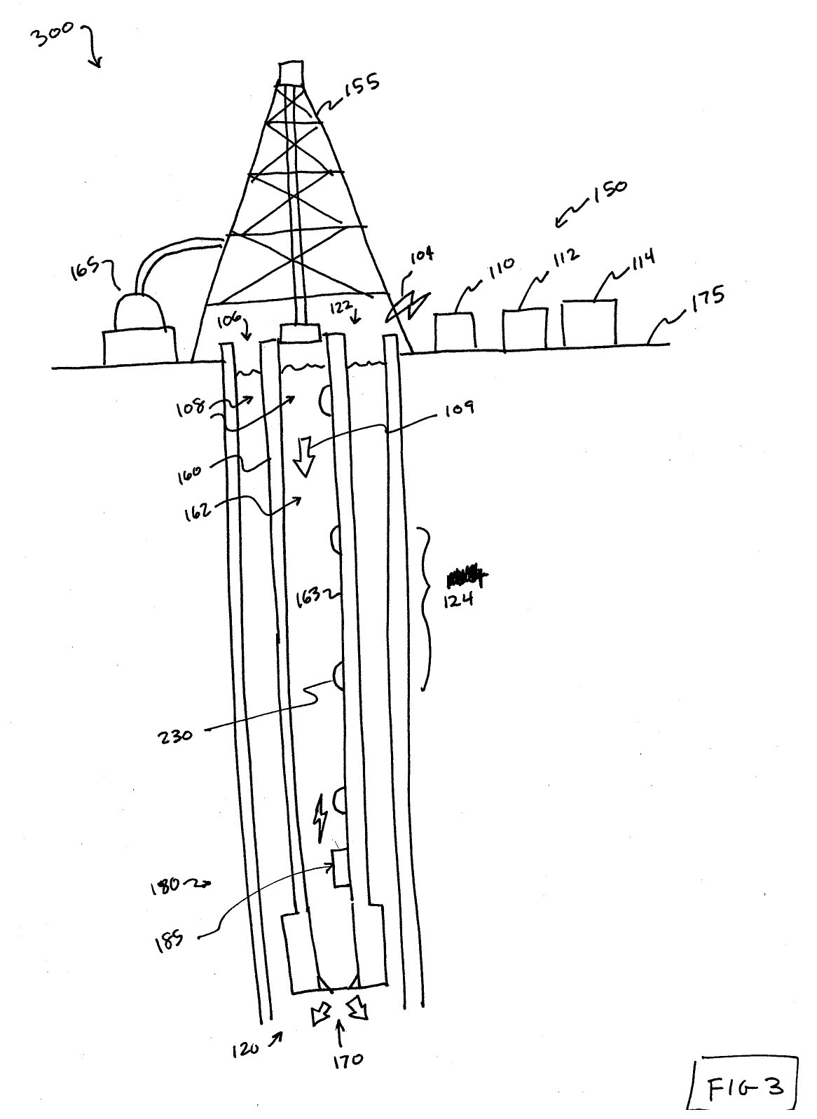

FIG. 3 shows another embodiment of positioning the MEMS radio units of the present invention. In this embodiment, MEMS radio units 230 are positioned or coupled to downhole tool interior 162. MEMS radio units 230 may be positioned or coupled to downhole tool interior 162 at selected separation distances 124. Separation distances 124 may be selected based on the individual transmission and receiving capabilities of MEMS radio units 230, e.g., taking into account mud 108 or other environmental factors. In other embodiments, MEMS radio units 230 may be positioned or coupled to the exterior of downhole tool 160 at selected separation distances 124.

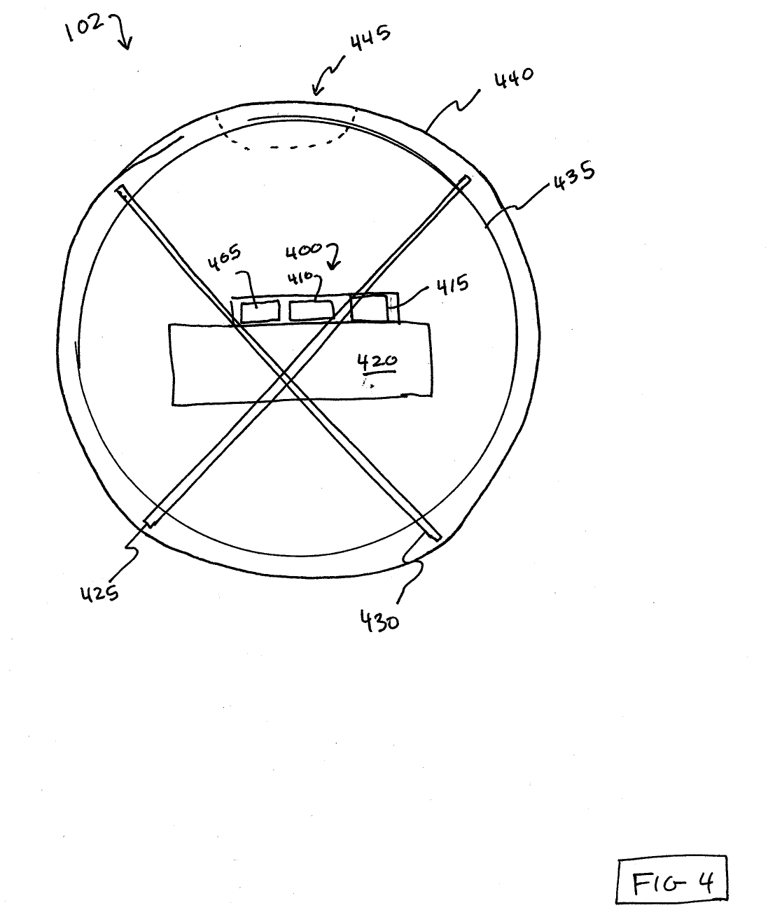

FIG. 4 shows an embodiment of the MEMS radio unit 102 used in the top-release and bottom-release systems shown in FIGS. 1 and 2. MEMS radio unit 102 includes radio transceiver 400 or similar wireless communications device that includes both transmitter and receiver capabilities, e.g., transmitter-receiver, transponder, transverter, repeater, among other examples. Radio transceiver 400 may include memory 405, microcontroller 410 and one or more sensors 415. Radio transceiver 400 is preferably selected for small size, being inexpensive and consuming small amounts of power, e.g., a 25 mm×25 mm chip. For example, radio transceiver 400 may lack a crystal oscillator circuit. Preferably, MEMS radio units 102 utilize amplitude-shift keying (ASK) to minimize the need for an accurate frequency synthesizer, e.g., to minimize the size and expense of components. Other modulation techniques may be used, such as frequency-shift keying (FSK), for example. MEMS radio units 102 preferably operate at the same frequency and on a single (and very wide) channel. Because the downhole environment is relatively quiet in the RF spectrum, the MEMS radio units may avoid modes which require expensive and power greedy components, e.g., direct sequence spread spectrum radio, for example.

Microcontroller 410 may provide system control and data management. Microcontroller 410 may also comprise the protocol for communication between the unit 102 and other devices. Memory 405 may comprise a data storage device to store ID information associated with the unit 102, a received data package, and ID information associated with the data package, among other data. MEMS radio unit 102 includes battery 420 or a similar power source for its components. Battery 420 may also include a battery charger, e.g., by induction. Sensors 415 may include temperature and pressure sensors, among other types of sensors. Accordingly, MEMS radio unit 102 may transmit sensor data along with the downhole information 104 received from downhole devices 180, e.g., temperature and sensor data.

MEMS radio unit 102 includes one or more antennas 425 and 430. Because MEMS radio unit 102 may constantly change orientation as it is carried along by drilling mud 108, the antenna(s) are preferably selected and positioned to allow MEMS radio unit 102 to transmit and receive signals in all directions. As shown in FIG. 4, antennas 425 and 430 may comprise coil antennas that wrap around the circumference of MEMS radio unit 102 to allow MEMS radio unit 102 to receive and transmit signals in substantially 360° of direction. The coil antennas may be selectively angled with respect to battery 420 to avoid interference from battery 420, e.g., at a 45° angle. Alternatively, antennas 425 or 430 may be other types of antenna including electrical dipole antenna, ceramic antenna or dielectric resonator antenna, for example. If MEMS radio unit 102 uses multiple antenna, the microcontroller 410 may implement an antenna diversity or multiple-input, multiple-output (MIMO) policy to select the antenna with the best reception to receive a particular incoming signal.

MEMS radio unit 102 is designed to be small enough to positioned into borehole 106 along with and, in certain embodiments, in downhole tool 160. For example, MEMS radio unit 102, as shown in FIG. 4, may have about a 10 mm outer diameter. Moreover, because MEMS radio units 102 may be placed in drilling mud 108 and move through drilling equipment under high pressure and high temperature, MEMS radio unit 102 preferably presents a smooth or low profile shape and includes one or more protective layers for its components. As shown in FIG. 4, MEMS radio unit 102 comprises a substantially spherical shape and an inner protective shell 435 to protect the electronics and outer protective shell 440 to protect antennas 425 and 430. Shells 435 and 440 may comprise epoxy, or similar material for example.

In order to conserve battery power, MEMS radio units 102 preferably include (or respond to) an activation device so that MEMS radio units 102 are activated (e.g., to transmit and receive data) only after they are released into drilling mud 108 or otherwise positioned into the downhole environment. For example, inner and/or outer shells 425 and 430 may include an area 445 that is thinner than the rest of the sphere. Accordingly, when the MEMS radio unit 102 is positioned in a high pressure environment such as drilling mud 108, sensor 415, which may be a pressure sensor, may detect the resulting pressure change. MEMS radio unit 102 may then activate its radio transceiver 400. Other types of activation may be used, including, for example, temperature.

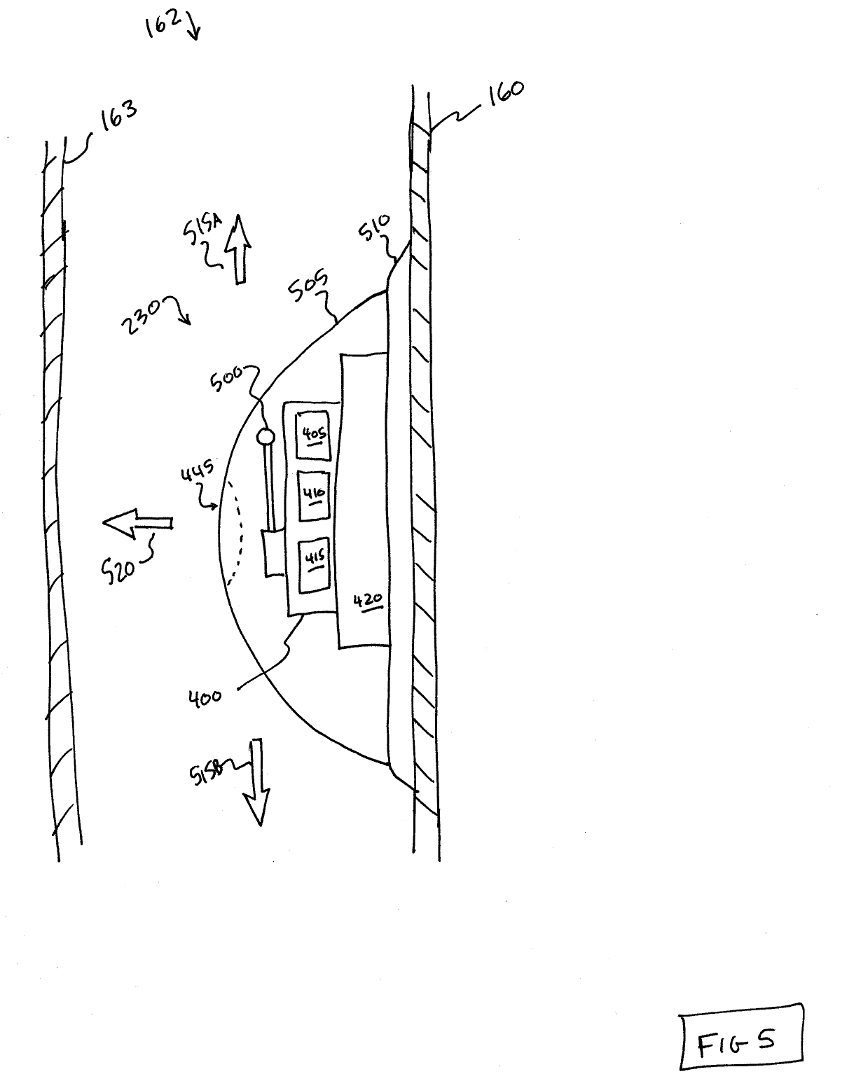

FIG. 5 shows an embodiment of the MEMS radio unit 230 used in the system shown in FIG. 3. MEMS radio units 230 may be coupled either permanently or semi-permanently to the interior wall 163 of downhole tool 160 via connector 510. For example, connector 510 may comprise a magnet to allow MEMS radio units 230 to be magnetically coupled to a metal surface such as downhole tool interior wall 163. Other methods of coupling MEMS radio units 230 to downhole tool interior 162 may be used, e.g., adhesives, welding, or mechanical coupling. Because MEMS radio units 230 are placed within (or on the exterior of) downhole tool 160, they are preferably shaped to minimize the obstruction of mud flow. For example, as shown in FIG. 5, MEMS radio unit 230 comprises a dome-shaped protective shell 505.

MEMS radio unit 230 includes one or more antenna 500. Antenna 500 is preferably designed and positioned to transmit and receive data substantially along directions 515A and 515B as any component of the transmission along direction 520 may bounce off the opposite interior wall 163 and cause signal interference. Antenna 500 may include one or more slot antennas, dielectric resonator antennas, uniplaner antennas, quasi-Yagi antennas, patch antennas, for example.

The MEMS radio units of the present invention may implement global and local protocol to transmit and receive data over network 116. For example, global protocol may define the minimum signal strength that an individual MEMS radio unit will accept before it receives an incoming signal, e.g., 10 microvolts/meter. Local protocol may implement carrier sense collision avoidance (CSCA) so that any given two MEMS radio units in the same local network will not attempt to transmit at the same time, e.g., a half-duplex communication scheme.

Once MEMS radio units are released into the system and activated, the units may enter a sleep mode and wake-up every 10 microseconds, for example, to listen for incoming signals. If an MEMS radio unit does not detect an incoming signal it will go back to sleep. If the MEMS radio unit does detect a signal, it may then determine whether the signal is directed at the MEMS radio unit or too weak, for example. If the signal is valid, the MEMS radio unit may determine if other MEMS radio units are also receiving the signal and, if so, negotiate with the other units to create a local network. Once this local network has been formed, the units may determine which unit will re-transmit the signal, e.g., the unit furthest uphole and closest to the surface devices. Each data package may be associated with its own ID number. To minimize data loss, two or more MEMS radio units may be used to carry the identical data package.

From the foregoing detailed description of specific embodiments of the invention, it should be apparent that a system and method for a transmitting and receiving data in a measurement-while-drilling (MWD) system that are novel have been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A system for transmitting measurement-while-drilling (MWD) data from at least one downhole device positioned within a borehole to at least one surface device, comprising:
a downhole tool positioned within the borehole;
a plurality of wireless MEMS radio units (MEMS);
wherein the MEMS radio units are selectively positioned within the borehole at selected distances to create a relay system between the downhole device and the surface device; and
wherein data from the downhole device is transmitted through the relay system of MEMS radio units to the surface device.

2. The MWD system of claim 1, wherein the downhole tool and the borehole both comprise drilling mud.

3. The MWD system of claim 2, wherein the MEMS radio units are positioned within the drilling mud in the downhole tool.

4. The MWD system of claim 3, wherein the downhole tool comprises a catch basin to collect MEMS radio units.

5. The MWD system of claim 2, wherein the MEMS radio units are operable to be positioned within the drilling mud in the borehole.

6. The MWD system of claim 5, wherein the downhole tool is operable to house the MEMS radio units and selectively release the MEMS radio units into the drilling mud in the borehole.

7. The MWD system of claim 6, wherein the downhole tool comprises a compartment unit, wherein the compartment unit comprises a storage chamber and a release chamber; wherein the storage chamber is operable to house the MEMS radio units and position a selected MEMS radio unit into the release chamber, and wherein the release chamber is operable to position the selected MEMS radio unit into the drilling mud in the borehole.

8. The MWD system of claim 7, wherein the downhole tool selectively releases the MEMS radio units based on the resistivity of the drilling mud in the borehole.

9. The MWD system of claim 2, wherein each MEMS radio unit comprises:
a first antenna;
a radio transceiver; and
a substantially spherical first shell housing the radio transceiver.

10. The MWD system of claim 9, wherein each MEMS radio unit further comprises a second antenna and a substantially spherical second shell housing the first and second antennas and the first shell.

11. The MWD system of claim 1, wherein the MEMS radio units are coupled to the downhole tool.

12. The MWD system of claim 11, wherein the downhole tool comprises an internal cavity having an interior wall, and wherein the MEMS radio units are coupled to the interior wall of downhole tool.

13. The MWD system of claim 12, wherein each MEMS radio unit comprises:
an antenna;
a radio transceiver;
a substantially hemispherical outer shell housing the radio transceiver; and
a connector operable to couple the MEMS radio unit to the downhole tool.

14. The MWD system of claim 13, wherein the connector comprises a magnet.

15. A method for transmitting measurement-while-drilling (MWD) data from at least one downhole device to at least one surface device, comprising the steps of:
positioning a plurality of wireless MEMS radio units within a borehole at selected locations;
creating a relay system between the downhole device and the surface device with the plurality of MEMS radio units, and
transmitting data from the downhole device through the relay system of MEMS radio units to the surface device.

16. The MWD method of claim 15, further comprising the steps of:
positioning a downhole tool within the borehole; and
circulating drilling mud through the downhole tool and the borehole.

17. The MWD method of claim 16, wherein the step of positioning the MEMS radio units further comprises the step of positioning the MEMS radio units within the drilling mud in the downhole tool.

18. The MWD method of claim 16, wherein the step of positioning the MEMS radio units further comprises the step of positioning the MEMS radio units within the drilling mud in the borehole.

19. The MWD method of claim 18, wherein the step of positioning the MEMS radio units within the drilling mud in the borehole further comprises the steps of:
housing the MEMS radio units within the downhole tool; and
selectively releasing the MEMS radio units from the downhole tool.

20. The MWD method of claim 16, wherein the step of positioning the MEMS radio units further comprises the step of coupling the MEMS radio units to the downhole tool at selected locations.
